(19) United States
(12) Patent Application Publication
(10) Pub. No.: US 2009/0031135 A1
(43) Pub. Date: Jan. 29, 2009

(54) Tamper Proof Seal For An Electronic Document

(76) Inventor: Raghunathan Kothandaraman, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/164,120

(22) Filed: Jun. 30, 2008

(30) Foreign Application Priority Data
Jul. 27, 2007 (IN) 1633/CHE/2007

(51) Int. Cl. H04L 9/00

(52) U.S. Cl. 713/176

(57) ABSTRACT

A method of generating a tamper proof seal 111 for an electronic document 104 includes retrieving information from data storage 102 to determine a process and data for generating a document signature. The document signature is created from contents of the electronic document 104 and using the process and the retrieved data. The seal 111 is generated. The seal 111 includes the document signature and information for generating the document signature separated by a delimiter.

### BACKGROUND

Business enterprises frequently transmit customer specific, critical information, such as invoices, receipts and account statements as digital documents. These documents usually form the basis of further communication between the sender, e.g., the enterprise, and the receiver, e.g., the end customer. Consider a scenario where an end customer reports a discrepancy in an invoice. It then becomes vital for the enterprise, which is the sender, to determine whether there is an actual discrepancy or detect willful tampering. Hence, the enterprise needs to verify the origin and the content of the digital document.

Conventional solutions for solving this problem include storage of the original information transmitted by the sender in a repository. Verification and tamper detection proceed by cross referencing the original copy with that presented by the receiver, which in the example above is the customer reporting the discrepancy in the invoice. These solutions, however, increase the amount of time to verify the received document, because an administrator at the enterprise has to identify the original document from the repository and retrieve the document for comparison to the received document. If the enterprise processes hundreds or thousands of invoices daily, a significant amount of time is wasted retrieving documents from the repository. Also, additional storage may be required to store the invoices.

### SUMMARY

A method of generating a tamper proof seal for an electronic document includes retrieving information from data storage to determine a process and data for generating a document signature. The document signature is created from contents of the electronic document and using the process and the retrieved data. The seal is generated. The seal includes the document signature and information for generating the document signature separated by a delimiter.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 illustrates a system, according to an embodiment;

FIGS. 2 illustrates a flow chart of a method for generating a tamper proof seal, according to an embodiment;

FIG. 3 illustrates a flow chart of a method for verifying a tamper proof seal, according to an embodiment; and

FIG. 4 illustrates a computer system, according to an embodiment.

### DETAILED DESCRIPTION OF THE EMBODIMENTS

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments.

According to an embodiment, a tamper proof seal is affixed to an original digital document. Affixing includes incorporating the seal in the document, transmitting the seal with the document or otherwise including the seal with the document. The seal may be plain ASCII text, which is suitable for conversion to many different formats. When a copy of the original digital document is received with the seal, the received copy is verified using the seal.

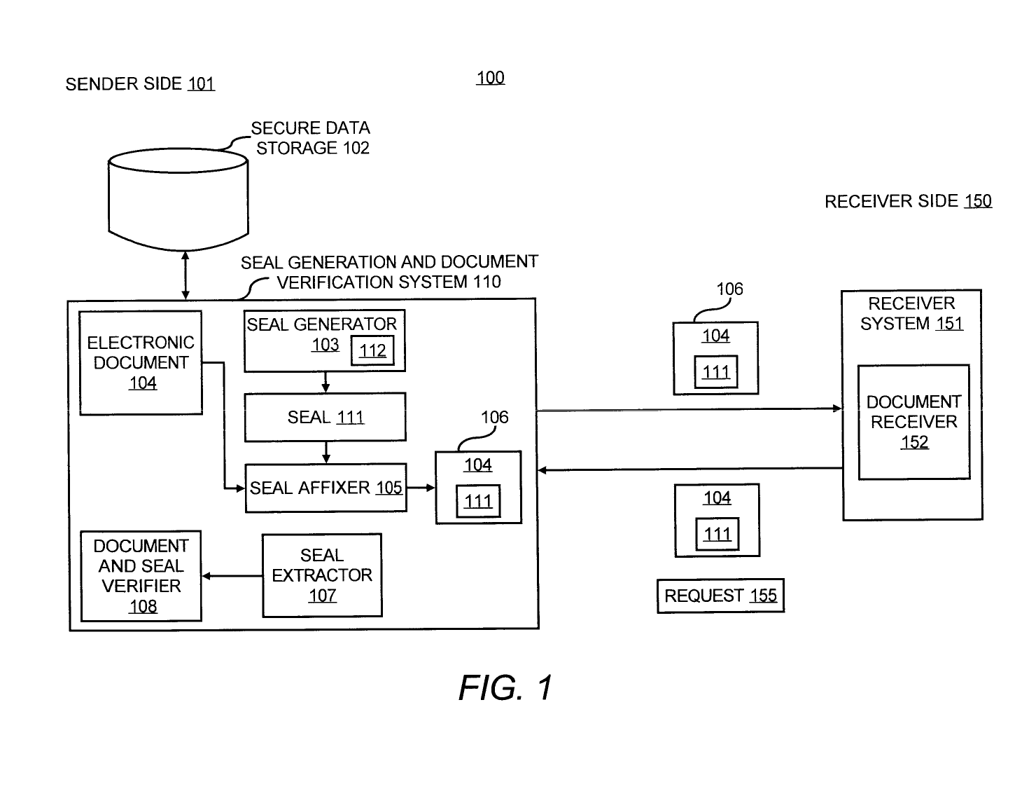

FIG. 1 illustrates a system 100, according to an embodiment. The system 100 includes a sender side 101 and a receiver side 150. The sender side includes a seal generation and document verification system 110 connected to a secure data storage 102 storing keys and other information for generating tamper proof seals, hereafter referred to as seals, and verifying documents using the seals, which is described in further detail below. The secure data storage 102 may also store documents and document hashes if needed. The secure data storage 102 is shown outside the seal generation and document verification system 110. For example, the secure data storage 102 may be maintained by a trusted third party. In another embodiment, the secure data storage 102 may be included in the seal generation and document verification system 110.

The seal generation and document verification system 110 includes a seal generator 103, a seal affixer 105, a seal extractor 107 and a document and seal verifier 108. The seal generator 103 and the seal affixer 105 generate tamper proof seals and affix the seals with digital documents, also referred to as electronic documents. FIG. 1 shows the seal generator generating a tamper proof seal 111. The seal affixer 105 receives the seal 111 and an electronic document 104, and affixes the seal 111 with the digital document 104, which is shown as the output 106 of the seal affixer 105. The electronic document 104 with the seal 111 is transmitted to the receiver side 150. The seal generation and document verification system 110 and the receiver system 151 may exchange information via a network, not shown, or through non-network communications.

The receiver system 151 receives the document 104 with the seal 111. A document reviewer 152 may review the document 104 to determine whether the information in the document 104 is accurate. For example, if the document 104 is an invoice, the document reviewer 152 reviews the document 104 to determine whether the purchased products or services and amounts are correct. If any of the information is incorrect, the receiver system 151 transmits the document 104 with the seal 111, which the receiver system 151 previously received from the seal generation and document verification system 110, back to the seal generation and document verification system 110 along with a request 155. The request 155 may be a request to correct or verify information in the document 104.

The seal generation and document verification system 110 receives the document 104 with the seal 111 and the request 155. The seal extractor 107 extracts the seal 111 from the document 104. If the seal 111 is incorporated in the document 104, such as the seal 111 being ASCII text in the document 104, which may be a PDF document or a text or word processing document. The seal extractor 107 identifies the seal within the document and extracts the seal 111, for example, through a cut and paste operation. The document and seal verifier 108 determines whether the document 104 received from the receiver system 151 is the same document 104 previously sent from the seal generation and document verification system 110 using the extracted seal 111. In some instances, a receiver on the receiver side 150 may attempt to send a modified version of the document 104 to the seal generation and document verification system 110. For example, the receiver may willfully tamper with an invoice to attempt to pay less than agreed upon for products or services. The seal generation and document verification system 110 determines whether the document 104 has been modified since it was transmitted to the receiver system 151 using the seal 111.

Depending on whether the document 104 received from the receiver system 151 is determined to be unmodified or not, the sender side 101 may act upon the request 155. For example, if the request 155 is to confirm receipt of payment, the seal generation and document verification system 110 may send the confirmation if the invoice is considered unmodified and was paid. The seal generation and document verification system 110 detects whether the seal 111 has been tampered with. If the seal 111 has not been tampered, it extracts the original information from the seal 111 and compares it with the document 104. This comparison may be fully automated or might just include software that will aid a visual manual comparison. Also, optionally to further strengthen the conclusion arrived at by the above comparison, the original documents (or their hash) that are transmitted to the receiver may be stored in the data storage 102 and the original may be compared to the received document if the comparison to information from the seal shows a mismatch. In one embodiment, the seal generation and document verification system 110 does not perform the comparison with the document 104. Instead, the information extracted from the seal 111 is used to act upon the request 155. Generally, document verification determines future courses of action.

Many of the components of the system 100 can be automated. For example, the seal generation and document verification system 110 may include a computer system. The seal generator 103, the seal affixer 105, the seal extractor 107 and the document and seal verifier 108 may be hardware or software or a combination of hardware and software. In one embodiment, these components may be software running on one or more processors. In other embodiments, one or more functions performed by the system 100 may be performed manually. For example, if the seal 111 is transmitted in an email, a user may manually insert the seal 111 and document 104 in the email and send the email to the receiver system 151. Also, the received document 104 and seal 111 may be extracted from the email by a user. Also, the document reviewer 152 at the receiver side 150 may be a person reviewing the document.

According to an embodiment, the seal generator 103 is operable to generate a seal, such as the seal 111, comprised of several delimited fields. For example, the seal may be in the following format: Esc[field1]Esc[field 2]Esc[Field 3]Esc[field 4]Esc[field 5]. The fields do not have to be in this order and the order is shown as an example. “Esc” is one example of a delimiter and it may be the default delimiter. Other ASCII characters, which may be letter sequences, can be used as a delimiter. A delimiter is a sequence of one or more characters used to specify the boundary between separate, independent regions or fields. The fields may be plain text. The brackets are shown in order to ease reading of the format. The brackets are not included in the seal unless they are in the delimiter. In case the delimiter itself occurs in the data, the seal may be in the format “dataEscEscdata”, which implies that Esc occurs as a part of the data and not as a delimiter. The seal may be ASCII code and use of a letter sequence as a delimiter merges the delimiter text with the base64 encoded seal. The seal is described as ASCII or in ASCII format, which means the seal is comprised of ASCII codes.

The seal may include one or more of the fields 1-5. The fields 1-5 include the following fields: field 1 is the electronic document compressed and encoded; field 2 is a key identifier; field 3 is an encoded digital signature of the electronic document, referred to as the document signature; field 4 is a timestamp of when the seal is created; and field 5 is a delimiter ID identifying the delimiter in the seal. The encoded digital signature in field 3, for example, is a hash of the electronic document or at least some of the data in the electronic document.

The secure data storage 102 may include a database storing information for generating the seals. The data storage 102 may be secured through encrypted communications or other known mechanisms for preventing unauthorized access to data. Examples of information stored in the secure data storage 102 include key ID, key, cryptographic function ID, hash function ID, timestamp and whether a key is stale or not. An entry in the database may include a value for each of these fields. The key ID is a unique ID for the key. The key ID may be used to index the database to identify an entry of interest. Thus, the key ID used as an index acts as an identifier to retrieve an entry. The key is a cryptographic key, such as a private key for asymmetric encryption or a symmetric key, which is compatible with the cryptographic function. The cryptographic function ID and the hash function ID identify the cryptographic function and hash function used to generate information for the seal, such as field 3 in the seal including the encoded digital signature. RSA and SHA-1 are examples of types of the functions. The timestamp is the key generation time, and the stale field 5 is used to mark keys that have expired. The timestamp and stale fields 4 and 5 may not be used for seal generation but need to be preserved for document verification. None of the fields may store a NULL value.

The seal generator 103 includes a key generator utility 112 for generating keys and storing the keys in the data storage 102. The key generator utility 112, for example, generates 2048 bit RSA keys and uses one or more of the cryptographic function ID, the hash function ID and the size of the keys to generate a key that may be used to encrypt the document signature. In one embodiment, the key generator utility 112 generates keys based upon the specific cryptographic function ID specified.

The seal extractor 107 extracts the seal from a document if it is incorporated in the document. This may include identifying the seal, for example, by parsing the document for a seal header or identifying the seal in a predetermined location in the document. Seal extraction may also be performed manually, for example, if the seal is sent as a separate file.

To determine whether the seal 111 has been tampered with in the document received from the receiver system 151, the document verifiers 08 extracts the document signature, e.g., field 3, from the seal 111. The document signature is decrypted and decoded which results in a hash referred to DH. This hash should be the hash of the electronic document 104. Also, the document and seal verifier 108 extracts the compressed document, e.g., field 1, from the seal 111. The compressed document is decoded and decompressed and a hash of the decompressed document is generated, referred to UH, using the same hash function used to generate the document signature in field 3. If DH does not equal UH then a determination is made that the seal 111 may have been tampered with. If DH equals UH, then the seal 111 has not been tampered with. Subsequently, the information generated from the seal 111, such as the uncompressed document, can be compared with the original document 104, which may be retrieved from the data storage 102, to detect whether the received document has been modified. It should be noted that the received seal may be parsed to identify information in different fields in the seal. Parsing the seal may be performed by determining the delimiter ID from the seal and using the delimiter to parse the seal. Also, the key ID, e.g., in field 2, may be used to retrieve the cryptographic function ID and hash ID to determine the cryptographic function for decrypting the document signature and for determining the hash function for hashing the uncompressed document.

According to an embodiment, the keys in the data storage may be randomized and/or the delimiter in the seal is randomized. Randomizing the keys and the delimiter makes unauthorized modification of the seal more difficult. It also provides for a one time upload of keys and delimiter patterns. This allows for longer key life periods, eases administration and significantly enhances security.

A randomizing function may be used to randomize selection from among a fixed set of data elements. This may be performed by assigning simple integers as identifiers (element identifier) to each data element and labeling the total number of data elements as N. Next, a prime number closest to N is determined and labeled P. For example, if N=8, then P=7. A pseudo random number generator generates a random integer value, I. Then, a compression map of the type (I mod P) is used to select a specific element identifier. Then, the data element corresponding to the element identifier is obtained by a lookup. The data elements may be stored in the secure data storage 102 and randomly selected as described above using the compression map. The data elements may include keys or delimiters, so the keys or delimiters may be randomly selected.

The compression map described above provides the randomization of the selection of the data element. Compression maps are well known. I mod P is one example of a compression map. Prime numbers yield better compression maps and hence a higher probability that two successive random numbers don't match the same pattern ID. Other types of compression maps, such as multiply add and divide (MAD), may be used.

The randomizing function may be used to randomize the delimiter. IDs are assigned to delimiters. Application of the randomizing function yields a randomly selected delimiter ID. This forms the delimiter ID field 5 in the seal. The delimiter ID is used to retrieve the corresponding delimiter from the secure data storage 102. The delimiters may include text strings, such as letters, of arbitrary lengths. Parsing in the verification phase, such as performed by the document and seal verifier 108 proceeds by processing the seal backwards till a first non number character. The result of this parse operation yields the delimiter ID. Further processing during the verification phase includes a simple lookup to retrieve the delimiter using the delimiter ID and identify the different fields in the seal. A successful parse acts as a first level check against seal tampering. The delimiter IDs may be stored in the data storage 102 or in a simple header file.

The randomizing function may be used to randomize the keys. Entries in data storage include a key ID. The key ID is split into a major and a minor version number. A combination of the major version number and the minor version number is unique and hence identifies a specific key. Major version numbers are associated with a cryptographic function ID-hashing function ID (CrF-HF) combination. A most recent CrF-HF combination has the highest value for the key ID, and more specifically is the highest value for the major version number. Randomizing the returned key then becomes equivalent to randomizing the selection of a minor version number given the highest major version number. A query of the form (select (count (minor_version_number)) from security key table, i.e., the data storage 102, where Stale=‘No’ and major_version_number=(select max (major_version_number) from security key table where Stale=‘No’)) yields the total number of keys that can be used, which is N described with respect to the randomizing function. Application of the randomization function yields a randomly selected minor version number and hence a random key for every invocation of the randomizing function. The value of the key ID is then changed to reflect this logic. For example, a value for the key ID may be 2/7, which is the major version number/minor version number.

The seals are generated using the keys in the secure data storage 102. For example, a key is retrieved from the secure data storage 102 to generate a seal. If a key is older than a predetermined time period, the key is marked as stale. For example, the timestamp associated with the key stores a timestamp indicated when the key was generated. The timestamp is compared with the current date. If it exceeds a threshold, the key is marked as stale in the data storage 102 and a new key is generated with a new key ID and stored in the data storage 102.

If the seal is incorporated in the electronic document instead of being sent as a separate file, the seal is visible to the receiver. To enhance user experience, the font size of the seal may be reduced. For example with a font size of 1 the seal is almost invisible. This conserves space on the electronic document and also reduces page count.

In one embodiment, the seal is ASCII codes and may be plain text ASCII codes, such as letters and number. Also, data from the electronic document used to generate the seal may be plain text. For example, the electronic document 104 is hashed to generate a document signature, which is used to generate the seal 111. Instead of hashing the entire electronic document 104, only the ASCII plain text in the electronic document 104 is hashed. In other embodiments, the entire document, which may be a WORD document or PDF document is hashed to create the document signature. Also, in one embodiment, the hash of the timestamp may be included in the document signature.

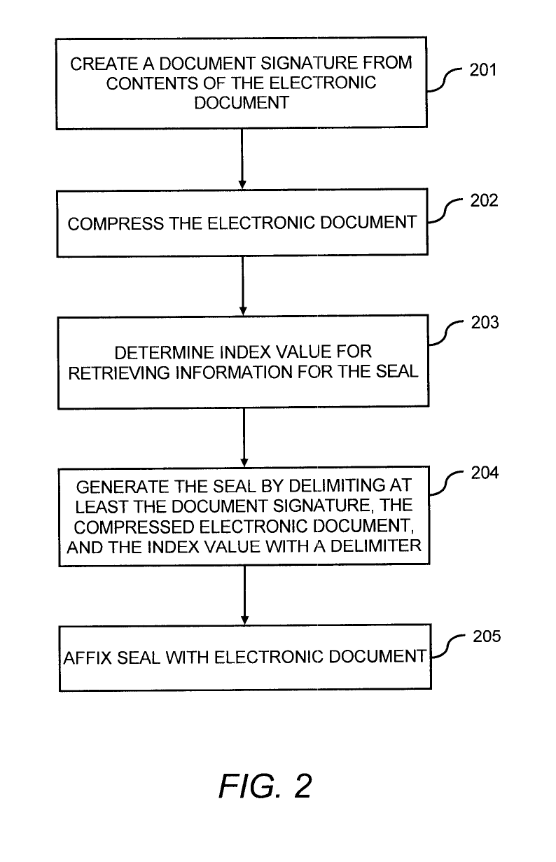

FIG. 2 illustrates a method 200 for generating a tamper proof seal, according to an embodiment. The method 200 is described with respect to FIG. 1 by way of example and not limitation. The method 200 may be practiced in other systems.

At step 201, a document signature is created from contents of the electronic document. For example, the seal generator 103 retrieves a key ID and information associated with key ID, including the key identified by the key ID, from the secure data storage 102. The information may also include a corresponding cryptographic function ID, hash function ID, timestamp for the key and whether the key is stale or not from the secure data storage 102. The seal generator 103 uses a hash function identified by the hash function ID to hash the electronic document 104 or portions thereof. This may include hashing each bit of the electronic document or only ASCII portions of the electronic document, such as plain text. The hashed electronic document is encrypted using the cryptographic function identified by the cryptographic function ID and using the key. Conventional types of one-way hash functions may be used, such as MD5. The encrypted hash may be converted to ASCII text by using encoding techniques like base64.

At step 202, the electronic document is compressed. A conventional compression function for compressing documents may be used, which may include PDF compression or text compression functions. If portions of the document are hashed rather than the entire document, then those portions are compressed and vice versa. The output of this step may again be converted to ASCII text using techniques similar to base64.

At step 203, an index value for retrieving information for the seal from data storage is determined. For example, the index value may be the key ID, which is associated with a hash function and cryptographic function and key used to create the document signature. The key ID and the associated information may be stored in a same entry in the data storage 102.

At step 204, the seal is generated by delimiting at least the document signature, the compressed electronic document, and the index value with a delimiter. Other information, such as the timestamp and the delimiter ID may be included in the seal. Delimiting may include providing the information in the seal in a sequence and separating the information with a delimiter.

At step 205, the seal is affixed with the electronic document.

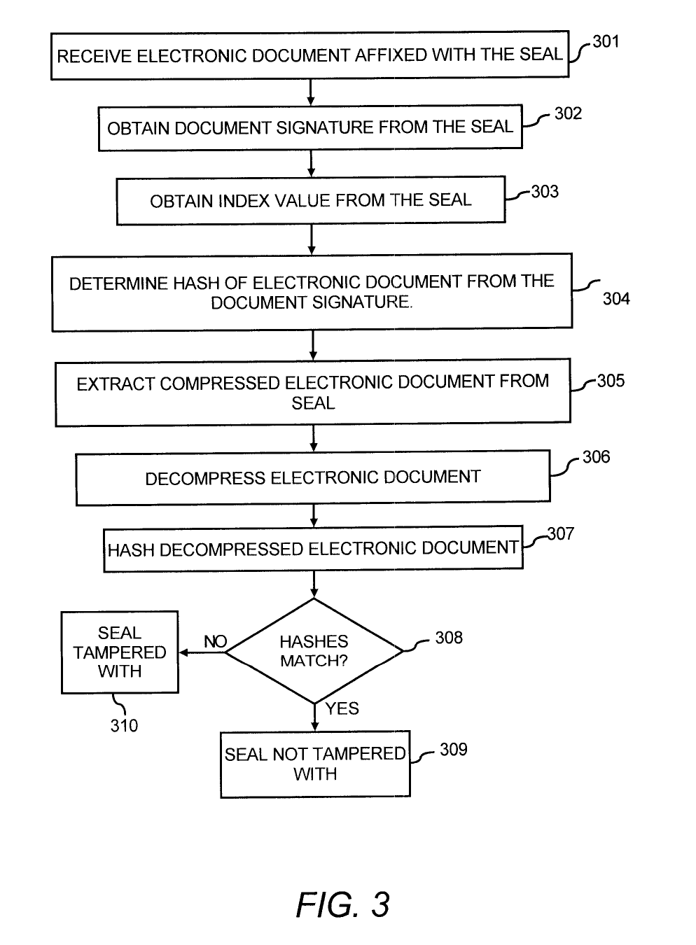

FIG. 3 illustrates a method 300 for verifying a tamper-proof seal, according to an embodiment. The method 300 is described with respect to FIG. 1 by way of example. For example, the document and seal verifier 108 shown in FIG. 1 performs one or more of the steps described below. It will be apparent to one of ordinary skill in the art that the method 300 may be practiced in other systems and one or more of the steps may be performed in other orders.

At step 301, an electronic document affixed with the seal is received. The seal includes at least a document signature for the electronic document, the compressed electronic document, and an index value, each of which is separated by a delimiter. The index value may be a key ID.

At step 302, the document signature is obtained from the seal. The document signature may be obtained by parsing and decoding the seal. Parsing is performed using the delimiter to distinguish between different information in the seal.

At step 303, an index value is obtained from the seal. For example, the seal is parsed to identify and extract the index value. The index value may be the key ID.

At step 304, a hash of the electronic document is determined from the document signature. For example, the document signature is a hash of the electronic document that is encrypted. The key ID, which is the index value in this example, is used to retrieve a hash function ID, a cryptographic function ID and the key used to generate the document signature from the data storage 102. The cryptographic and hash function ID's correspond to cryptographic and hashing methods like RSA and SHA-1 respectively. The key and the cryptographic function are used to decrypt the document signature. The decrypted document signature is a hash of the electronic document 104 if the seal 111 is not tampered with.

At step 305, the compressed electronic document is extracted from the seal.

At step 306, the compressed electronic document is decoded and decompressed.

At step 307, the decompressed electronic document is hashed. For example, the hash function corresponding to the hash function ID is used to hash the decompressed electronic document. This is the same hash function used to create the document signature.

At step 308, the hash from step 304 is compared to the hash from step 307. If the hashes match, the seal is determined not to be tampered with, i.e., not modified, at step 309. Then, the seal may be used to verify the electronic document is the same electronic document that was originally sent to the receiver, i.e., the received electronic document is authentic. For example, the contents of the uncompressed electronic document from the seal may be further processed. The contents may be displayed or cross-checked with the contents of the document sent by the receiver. Verification subsequent to uncompressing might proceed either manually or can be automated.

If the hashes do not match, a determination is made the seal is tampered with, i.e., modified, at step 310. Then, the original document 104 may be retrieved from the data storage 102 to identify differences from the received document.

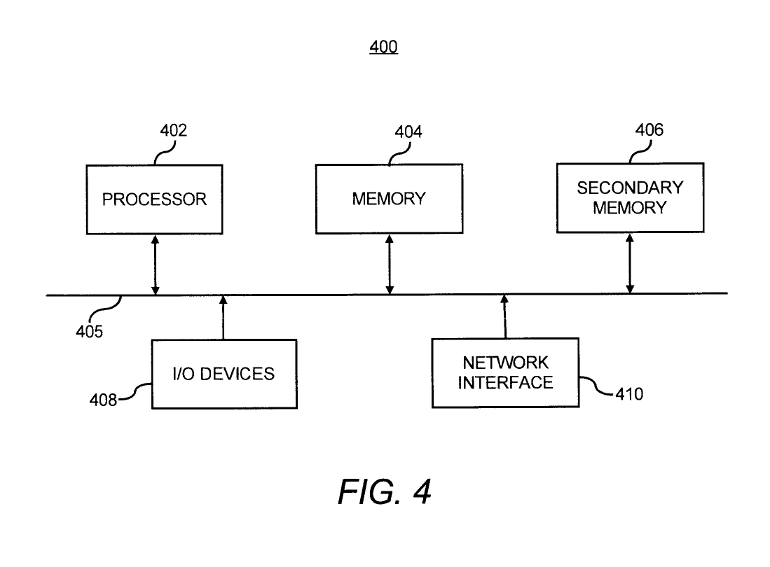

FIG. 4 illustrates an exemplary block diagram of a computer system 400. The computer system 400 may be used as a platform for running one or more of the components shown in FIG. 1. The computer system 400 includes one or more processors, such as processor 402, providing an execution platform for executing software.

Commands and data from the processor 402 are communicated over a communication bus 405. The computer system 400 also includes a main memory 404, such as a Random Access Memory (RAM), where software may be resident during runtime, and a secondary memory 406. The secondary memory 406 includes, for example, a hard disk drive and/or a removable storage drive, representing a floppy diskette drive, a magnetic tape drive, a compact disk drive, etc., or a nonvolatile memory where a copy of the software may be stored. The secondary memory 406 may also include ROM (read only memory), EPROM (erasable, programmable ROM), EEPROM (electrically erasable, programmable ROM). In addition to storing software, the data storage 404 or 406 may be used to store any information for generating a tamper proof seal or verifying an electronic document as described in the embodiments above.

A user interfaces with the computer system 400 with one or more I/O devices 408, such as a keyboard, a mouse, a stylus, display, and the like. A network interface 410 is provided for communicating with other computer systems via a network. For example, the network interface operates as a transmitter and a receiver.

One or more of the steps of the methods 200 and 300 and other steps described herein may be implemented as software embedded on a computer readable medium, such as the memory 404 and/or 406, and executed on the computer system 400, for example, by the processor 402. The steps may be embodied by a computer program, which may exist in a variety of forms both active and inactive. For example, they may exist as software program(s) comprised of program instructions in source code, object code, executable code or other formats for performing some of the steps. Any of the above may be embodied on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated below may be performed by any electronic device capable of executing the above-described functions.

While the embodiments have been described with reference to examples, those skilled in the art will be able to make various modifications to the described embodiments without departing from the scope of the claimed embodiments.

What is claimed is:

1. A method of generating a tamper proof seal for an electronic document, the method comprising:
retrieving information from a data storage 102 to determine a process and data for generating a document signature;
creating the document signature from contents of the electronic document 104 and using the process and the retrieved data; and
generating the seal 111, wherein the seal 111 includes the document signature and information for generating the document signature separated by a delimiter.

2. The method of claim 1, wherein the seal 111 is comprised of only ASCII code.

3. The method of claim 1, wherein the at least one process comprises at least one of a cryptographic function and a hash function.

4. The method of claim 1, wherein the information for generating the document signature comprises an index value identifying other information for generating the document signature, and the index value is included in the seal 111 separated by the delimiter.

5. The method of claim 4, wherein the information for generating the document signature comprises the electronic document 104 in a compressed form also separated by the delimiter in the seal 111.

6. The method of claim 5, wherein the information for generating the document signature comprises a delimiter ID identifying the delimiter, wherein the delimiter ID is also separated by the delimiter in the seal 111.

7. A method of determining whether a seal affixed with an electronic document has been tampered with, the method comprising:
receiving the electronic document 104 affixed with a seal 1 11, wherein the seal 111 includes at least a document signature for the electronic document 104 and the electronic document 104 compressed, each of which is separated by a delimiter;
determining a first hash from the document signature in the seal 111;
decompressing the compressed electronic document 104 from the seal 111;
determining a second hash which includes a hash of the decompressed electronic document 104 from the seal 111; and
determining whether the seal 111 has been modified with by comparing the first hash and the second hash.

8. The method of claim 7, wherein if the seal 111 has not been modified, the method further comprising:
comparing the decompressed electronic document with the received electronic document 104, to determine whether the received electronic document 104 has been modified.

9. The method of claim 7, wherein if the seal 111 has been modified, comparing the received electronic document 104 with an original stored version of the electronic document to identify any differences between the documents.

10. The method of claim 7, wherein the document signature is an encrypted hash of the electronic document 104 and determining a first hash from the document signature in the seal comprises:
decrypting the document signature to determine the first hash.
